(19) United States
(12) Patent Application Publication
(10) Pub. No.: US 2010/0250731 A1
(43) Pub. Date: Sep. 30, 2010

(54) SYSTEMS AND METHODS FOR APPLICATION IDENTIFICATION

(76) Inventor: Haitao XIAO, Wuhan (CN)

Correspondence Address: PATENT PROSECUTION;O2MIRCO , INC., 3118 PATRICK HENRY DRIVE, SANTA CLARA, CA, 95054, US

(21) Appl. No.: 12/414,905

(22) Filed: Mar. 31, 2009

(51) Int. Cl. G06F 15/16; G06N 5/02

(52) U.S. Cl. 709/224; 706/47; 706/59

(57) ABSTRACT

An application identification system includes a network interface, a signature monitor, a rule generator and a packet access controller. The network interface is operable for receiving first and second packets transmitted by a network application. The signature monitor coupled to the network interface is operable for identifying the network application based on a first packet transmitted by the network application and for generating monitoring data indicative of a state of the first packet. The rule generator coupled to the signature monitor is operable for generating a rule according to the monitoring data and according to a state machine indicative of a state transition between the first and second packets transmitted by the network application. The packet access controller coupled to the rule generator is operable for identifying the network application if the second packet contains contents matched to the rule.

### BACKGROUND

Network traffic is composed of many applications, including Internet applications such as web, mail, Peer-to-peer (P2P), Instant Message (IM), and other types of applications. For example, P2P file sharing applications and IM applications have grown in popularity over the past few years. Unmanaged usages of P2P/IM applications may cause problems, e.g., occupied bandwidth of Internet Service Provider (ISP), loss of confidential information, viruses, worms, and spyware. Internet service providers can identify packets transmitted by different applications to impose security policies on the networks. In some circumstances, packets from unknown and possibly harmful applications can be blocked to protect the network resources.

In earlier days, network applications transmit packets by using static and standard ports, and the conventional method relying on the standard ports (port based identification) can identify packets from different applications. Network applications can also transmit packets by using dynamic and non standard ports. A signature based identification method inspects whether the packets carry predetermined signatures to determine the application sources of the packets. A signature is a “fingerprint” describing uniquely a set of features of a packet.

However, some network applications can now transmit encrypted packets to avoid being recognized by the port based identification and signature based identification methods.

### SUMMARY

In one embodiment, an application identification system includes a network interface, a signature monitor, a rule generator and a packet access controller. The network interface is operable for receiving first and second packets transmitted by a network application. The signature monitor coupled to the network interface is operable for identifying the network application based on a first packet transmitted by the network application and for generating monitoring data indicative of a state of the first packet. The rule generator coupled to the signature monitor is operable for generating a rule according to the monitoring data and according to a state machine indicative of a state transition between the first and second packets transmitted by the target network application. The packet access controller coupled to the rule generator is operable for identifying the network application if the second packet includes contents matched to the rule.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a computer network system, in accordance with one embodiment of the present invention.

FIG. 2 illustrates a block diagram of an application identification component of FIG. 1, in accordance with one embodiment of the present invention.

FIG. 3A illustrates an example of the monitoring data of FIG, 2, in accordance with one embodiment of the present invention.

FIG. 3B illustrates an example of the state machine of FIG. 2, in accordance with one embodiment of the present invention.

FIG. 3C illustrates an example of the rule of FIG. 2, in accordance with one embodiment of the present invention.

FIG. 4 illustrates a flowchart of operations performed by an application identification device, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “receiving,” “generating,” “identifying,” “selecting,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present disclosure provide a system and a method for application identification. Advantageously, an application identification device can identify a target network application based on an unencrypted packet transmitted by the target network application and can generate a rule according to monitoring data indicative of a state of the unencrypted packet and according to a state machine indicative of a state transition between unencrypted and encrypted packets of the target network application. Therefore, the target network application can also be identified based on encrypted packets transmitted by the target network application according to the rule. Advantageously, the application identification device can identify both unencrypted and encrypted packets transmitted by the same target network application.

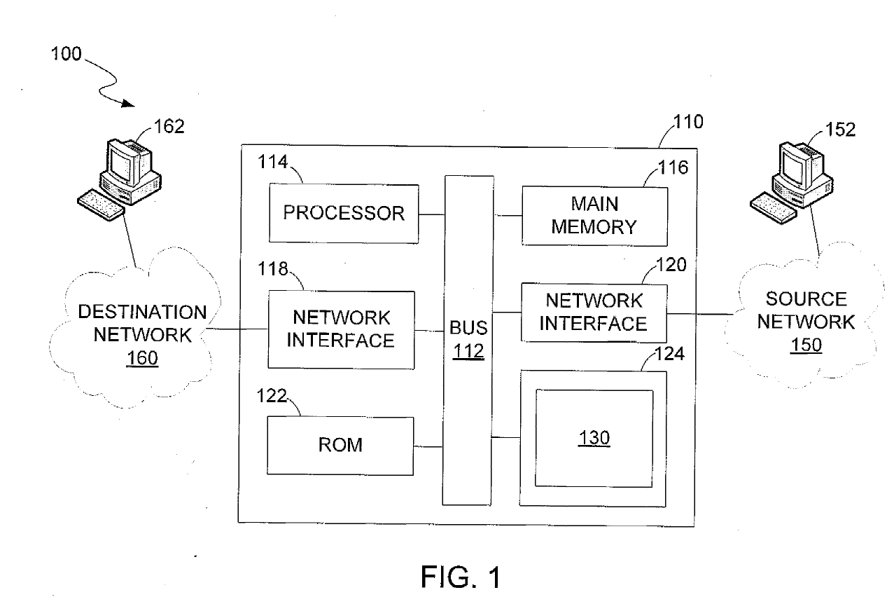

FIG. 1 illustrates a block diagram of a computer network system 100, in accordance with one embodiment of the present invention. The computer network system 100 can include a source network 150, a destination network 160 and an application identification device 110. The source network 150 and the destination network 160 can be, but are not limited to, home area networks (HANs), local area networks (LANs), metropolitan area networks (MANs), wide area networks (WANs), etc. The source network 150 and the destination network 160 can be coupled to two network nodes respectively, e.g., a source node 152 coupled to the source network 150, and a destination node 162 coupled to the destination network 160. The network node, e.g., the source node 152 or the destination node 162, can be a data circuit-terminating equipment (DCE) such as a modem, a hub, a bridge, a switch, etc., or a data terminal equipment (DTE) such as a digital telephone handset, a printer, a host computer (e.g., a router, a workstation or a server), etc.

In the example of FIG. 1, various network applications running on the source node 152 can transmit packets to the destination node 162 for network communications. The source network 150 and the destination network 160 can transfer the packets between the source and destination nodes 152 and 162. The application identification device 110 is coupled between the source network 150 and the destination network 160 to protect network resources.

In one embodiment, the application identification device 110 defines target network applications which may be restricted or prohibited according to network management policies. Accordingly, the transmission of packets sent from the target network applications can be restricted or prohibited. The application identification device 110 can inspect an application source of a packet sent from the source node 152 to determine whether the application source belongs to the target network applications that are restricted or prohibited. If the application source of a packet sent from the source node 152 via the source network 150 belongs to the target network applications, the application identification device 110 can identify that application source. Upon identification, the application identification device 110 can also restrict transmission of the packet to the destination network 160 according to the identified application source. Examples of the restrictions can include, but are not limited to, dropping the packet, limiting the packet transmission speed or checking chat recording. If the application source does not belong to the target network applications according to the packet inspection, the application identification device 110 can forward the packet to the destination node 162 via the destination network 160.

Advantageously, the application identification device 110 can identify both unencrypted and encrypted packets transmitted by the target network applications. In one embodiment, the target network applications running on the source node 152 will terminate packet transmission if successful communication with the destination node 162 can not be established after a predetermined period of time T1.

By way of example, a P2P/IM application that is restricted under network management policies can transmit an unencrypted packet. The unencrypted packet can include communication data and state data. The communication data, such as texts, images, audios or videos, can indicate information to be transmitted from the source node 152 to the destination node 162. The state data, such as a protocol, source and destination internet protocol (IP) addresses and source and destination ports, can determine a transmission state of the unencrypted packet. In addition, the unencrypted packet can have a signature that represents a set of unique features of the P2P/IM application. Examples of the signatures can be, but are not limited to, a particular character string contained in the communication data or a particular setting (e.g., a standard port) contained in the state data. Thus, the signature carried by the unencrypted packet indicates the identity of the corresponding source application which transmits such packet. The application identification device 110 can identify the P2P/IM application based on a signature identification method and drop the packet according to the network management policies.

If the unencrypted packet is dropped, the P2P/IM application running on the source node 152 can encrypt the unencrypted packet, e.g., by using one or more encryption algorithms to encrypt the communication data and/or changing settings of the state data, and can resend an encrypted packet to the destination node 162. As such, the signature contained in the prior unencrypted packet can be omitted in the encrypted packet, and the transmission state of the encrypted packet may be different from that of the unencrypted packet. Advantageously, the application identification device 110 can still recognize that the encrypted packet is transmitted from the P2P/IM application and impose the network management restrictions accordingly. Similarly, the corresponding encrypted packet can be dropped. Thus, if unsuccessful transmission or communication lasts longer than a certain period of time, e.g., T1, the P2P/IM application will stop transmitting any packet (unencrypted or encrypted), in one embodiment.

The application identification device 110 can be a general-purpose computer such as a personal computer (PC), a special-purpose computer system such as an embedded system, or any other computer-functional devices or systems. In one embodiment, the application identification device 110 includes a bus 112, a processor 114, a main memory 116, a read-only memory (ROM) 122 and a storage device 124. The bus 112 can be, but is not limited to, a data bus, an address bus and a controlling bus, and is capable of transferring information, e.g., data, instructions, address information, controlling commands, etc. The processor 114 can process various tasks and execute various instructions. The main memory 116, e.g., a random access memory (RAM) or other types of dynamic storage medium, can store information and instructions to be executed by the processor 114. The read-only memory (ROM) 122 or other types of static storage medium can store static information and instructions. The storage device 124, e.g., a magnetic disk or optical disk, can store computer-readable information and instructions.

More specifically, in one embodiment, instructions of a program module can be read into the main memory 116 from other storage media, e.g., the ROM 122 or the storage device 124. The processor 114 can execute the plurality of instructions in the main memory 116 to perform various tasks. For example, the processor 114 can read/write data from/to a storage medium (e.g., the main memory 116, the ROM 122 or the storage device 124) and can also process data and exchange information with the source network 150 and the destination network 160 according to the instructions.

In one embodiment, the application identification device 110 can further include a network interface 118 and a network interface 120. A network interface or a network card, e.g., the network interface 118 or the network interface 120, can be an Ethernet interface, a fiber distributed data interface (FDDI), or other types of interfaces. The network interface 118 coupled between the bus 112 and the destination network 160 is operable for connecting the application identification device 110 to the destination network 160. Similarly, the network interface 120 coupled between the bus 112 and the source network 150 is operable for connecting the application identification device 110 to the source network 150. As such, the application identification device 110 interfaces with the source network 150 and the destination network 160 via the network interface 120 and the network interface 118, respectively. The application identification device 110 can have other configurations and components within the scope and spirit of the claims, and is not limited to the example of FIG. 1.

In the example of FIG. 1, the storage medium 124 can store an application identification component 130 having program modules with instructions and data for identifying packets sent by various network applications, e.g., P2P or IM applications. During operation, programs/instructions of the application identification component 130 can be read into the main memory 116. If a packet is received from a computer network, e.g., the source network 150, the processor 114 can call the application identification component 130 and can execute the program modules to identify the application source of the packet.

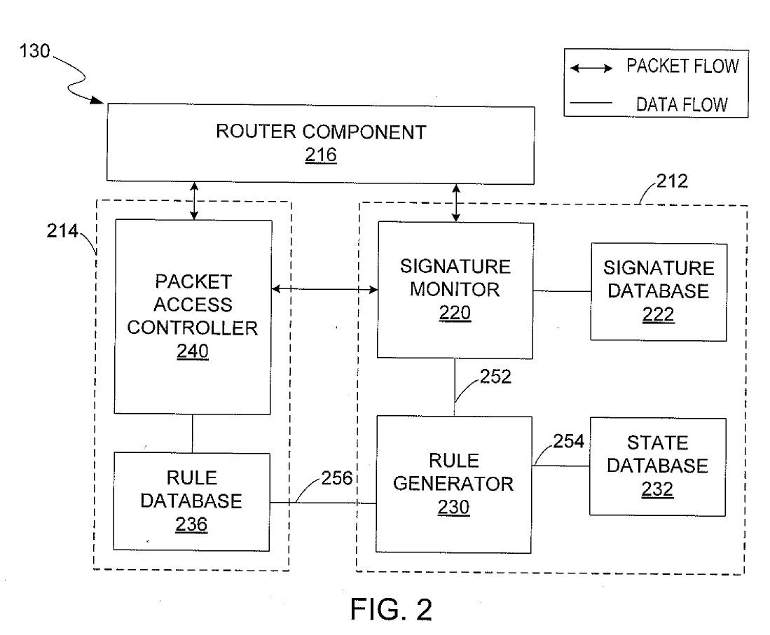

FIG. 2 illustrates a block diagram of an application identification component 130 of FIG. 1, in accordance with one embodiment of the present invention. FIG. 2 is described in combination with FIG. 1. A single block in FIG. 2 may be described as performing a function or functions; however, in actual practice, the function or functions performed by that block may be performed in a single component or across multiple components, and/or may be performed using hardware, using software, or using a combination of hardware and software.

In the example of FIG. 2, the application identification component 130 includes an unencrypted packet identifier 212, an encrypted packet identifier 214 and a router component 216. The unencrypted packet identifier 212 is operable for identifying an unencrypted packet transmitted by a target network application and for generating a rule. The encrypted packet identifier 214 coupled to the unencrypted packet identifier 212 is operable for identifying the corresponding encrypted packet transmitted by the target network application according to the rule generated by the unencrypted packet identifier 212. The router component 216 is operable for forwarding a packet to the destination node 162, e.g., if the packet is not identified as being transmitted by one of the target network applications.

In one embodiment, the unencrypted packet identifier 212 includes a signature monitor 220 and a signature database 222 coupled to the signature monitor 220. The signature database 222 is capable of storing predetermined signatures, each of which is indicative of one of the target network applications (e.g., P2P or IM). The signature monitor 220 is operable for inspecting unencrypted packets transmitted by various network applications according to the signatures stored in the signature database 222.

More specifically, the signature monitor 220 can receive and inspect a packet by comparing contents of the packet with the predetermined signatures in the signature database 222. If the packet contains contents matched to one of the predetermined signatures (e.g., P2P/IM signature), the signature monitor 220 can identify the packet as an unencrypted packet transmitted from a target network application (P2P/IM).

Furthermore, the signature monitor 220 is capable of generating monitoring data 252 indicative of a state of the identified unencrypted packet. In one embodiment, the monitoring data 252 is generated by fetching state information, e.g., state data, contained in the identified unencrypted packet.

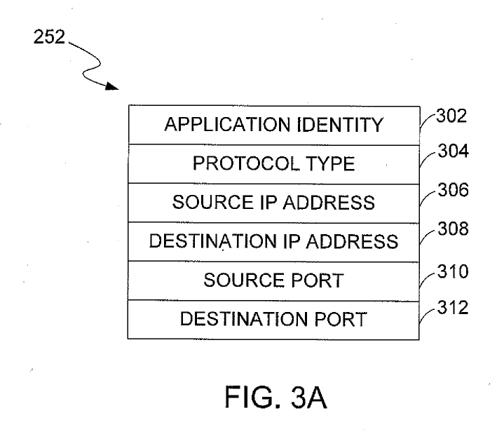

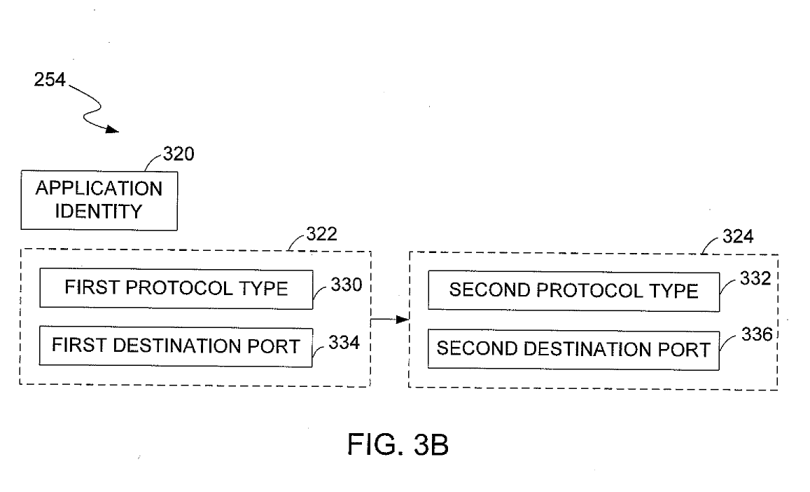

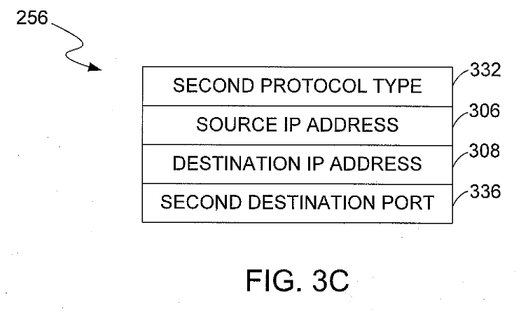

FIG. 3A illustrates an example of the monitoring data 252, in accordance with one embodiment of the present invention. In the example of FIG. 3A, the monitoring data 252 can include an application identity 302, a protocol type 304, a source internet protocol (IP) address 306, a destination IP address 308, a source port 310 and a destination port 312. The application identity 302 can represent an identity of the target network application that transmits the identified unencrypted packet. The protocol type 304 can represent a type of a protocol used by the identified unencrypted packet. The source IP address 306 can represent an IP address of the source node 152. The destination IP address 308 can represent an IP address of the destination node 162. The source port 310 can represent a port used by the identified unencrypted packet at the source node 152. The destination port 312 can represent a port used by the identified unencrypted packet at the destination node 162. In this way, the monitoring data 252 can indicate the state of the identified unencrypted packet. The monitoring data 252 can have other configurations, and is not limited to the example of FIG. 3A.

Turning back to FIG. 2, in one embodiment, the unencrypted identifier 212 further includes a rule generator 230 coupled to the signature monitor 220 and a state database 232 coupled to the rule generator 230. As discussed in relation to FIG. 1, if the unencrypted packet transmitted by the target network application is identified as transmitted by a target network application, the unencrypted packet can be dropped in accordance with the imposed restrictions. Subsequently, the same target network application may resend a corresponding encrypted packet. Advantageously, the state database 232 is operable for storing state machines, each of which can indicate a state transition between an unencrypted packet and a corresponding encrypted packet transmitted by one of the target network applications. The state machines can be used to generate a rule to identify the corresponding encrypted packet sent by the target network application.

FIG. 3B illustrates an example of a state machine 254, in accordance with one embodiment of the present invention. In the example of FIG. 3B, the state machine 254 can include an application identity 320, a first packet state 322 and a second packet state 324. The application identity 320 can represent the identity of the target network application. The first packet state 322 is associated with the unencrypted packet transmitted by the target network application. The second packet state 324 is associated with the corresponding encrypted packet transmitted by the same target network application. Therefore, the state machine 254 can be used to represent the state transition between the unencrypted packet and the corresponding encrypted packet transmitted by the same target network application.

In one embodiment, the first packet state 322 can include a first protocol type 330 indicative of a protocol type used by the unencrypted packet, and a first destination port 334 indicative of a destination port for the unencrypted packet. The second packet state 324 can include a second protocol type 332 indicative of the type of a protocol used by the encrypted packet, and a second destination port 336 indicative of a destination port for the encrypted packet. The state machine 254 can have other configurations, and is not limited to the example of FIG. 3B.

In one embodiment, the signatures in the signature database 222 and the state machines in the state database 232 can be predetermined or programmed by users. Moreover, the signatures in the signature database 222 and the state machines in the state database 232 can be updated. For example, if a network application is defined as a target network application which may be restricted or prohibited according to network management policies, the packet transmission of the network application can be examined. Thus, the signatures of the unencrypted packets can be read into the signature database 222 to update the signatures in the signature database 222. Moreover, a state transition, e.g., differences of state data between an unencrypted and a corresponding encrypted packet, can be read into the state database 232 to update the state machines in the state database 232.

Turning back to FIG. 2, the rule generator 230 receives the monitoring data 252 indicative of the state of the identified unencrypted packet and receives the state machine 254 indicative of the state transition between the identified unencrypted packet and the corresponding encrypted packet sent by the same target network application. According to the monitoring data 252 and the state machine 254, the rule generator 230 generates a rule 256 for identifying the corresponding encrypted packet, in one embodiment. More specifically, the rule generator 230 can look up the state database 232 and can select a state machine 254 from the state database 232 if the application identity 320 and the first packet state 322 in the corresponding state machine 254 are matched to the monitoring data 252. For example, the state machine 254 is selected if the application identity 302 matches to the application identity 320, the protocol type 304 matches to the first protocol type 330, and the destination port 312 matches to the first destination port 334. Consequently, the rule 256 can be generated according to a combination of the monitoring data 252 and the state machine 254, in one embodiment.

FIG. 3C illustrates an example of the rule 256, in accordance with one embodiment of the present invention. FIG. 3C is described in combination with FIG. 3A and FIGS. 3B. Elements labeled the same in FIG. 3A and FIG. 3B have similar functions.

In the example of FIG. 3C, the rule generator 230 fetches the second protocol type 332 from the state machine 254, the source IP address 306 from the monitoring data 252, a destination IP address 308 from the monitoring data 252, and the second destination port 336 from the state machine 254, and generates the rule 256 by combining the fetched data.

Turning back to FIG. 2, the encrypted packet identifier 214 includes a packet access controller 240 and a rule database 236, in one embodiment. The rule database 236 coupled between the rule generator 230 and the packet access controller 240 is capable of storing rules generated by the rule generator 230.

In one embodiment, the rule 256 can be effective for a predetermined time period T2. As described in relation to FIG. 1, the target network applications running on the source node 152 will terminate packet transmission if successful communication with the destination node 162 can not be established after a predetermined period of time T1. The predetermined time period T2 can be set to an amount that is greater than the predetermined time period T1. If the predetermined time period T2 expires, the rule 256 can be automatically deleted from the rule database 236. As such, the storage space of the rule database 236 can be used to store other rules.

In one embodiment, the packet access controller 240 coupled to the signature monitor 220 and to the rule database 236 is operable for identifying the corresponding encrypted packet of the target network application according to the rule 256 stored in the rule database 236. More specifically, the packet access controller 240 can receive and inspect the corresponding encrypted packet transmitted by the target network application. If the corresponding encrypted packet contains contents (e.g., state data) matched to the second protocol type 332, the source IP address 306, the destination IP address 308, and the second destination port 336 of the rule 256, the target network application can still be identified. As such, the application identification device 110 can identify both unencrypted and encrypted packets transmitted by the target network applications.

In one embodiment, the router component 216 is operable for forwarding a packet to the destination node 162, e.g., if the packet is not transmitted by the target network applications as determined by the signature monitor 220 or the packet access controller 240. More specifically, in one embodiment, the router component 216 can include a routing table (not shown) having information of available routes and route conditions, and can employ the routing table to determine the best route for the packet. As such, the packet can be forwarded to the destination node 162 according to the determined route.

The application identification component 130 is well suited to identifying various types of packets within the scope and spirit of the claims, and is not limited to the examples in FIG. 2, FIG. 3A, FIG. 3B and FIG. 3C. For example, in a multi-packet network system, multiple types of packets, e.g., a first packet, a second packet and a third packet, can be successively transmitted by the same target network application. The state database, e.g., the state database 232, can store multiple state machines, e.g., a first state machine indicative of a state transition between the first and the second packet, and a second state machine indicative of a state transition between the second and the third packet. The state machine is not limited to indicate a state transition between an unencrypted packet and an encrypted packet. The state machine can also indicate a state transition between two unencrypted packets or between two encrypted packets. If the target network application is identified based on the first packet, a first rule can be generated according to monitoring data of the first packet and the first state machine. Subsequently, if the second packet is received, the target network application can be identified based on the second packet according to the first rule. Similarly, a second rule can be generated according to monitoring data of the second packet and the second state machine. In this way, the target network application can be identified based on the third packet according to the second rule if the third packet is received.

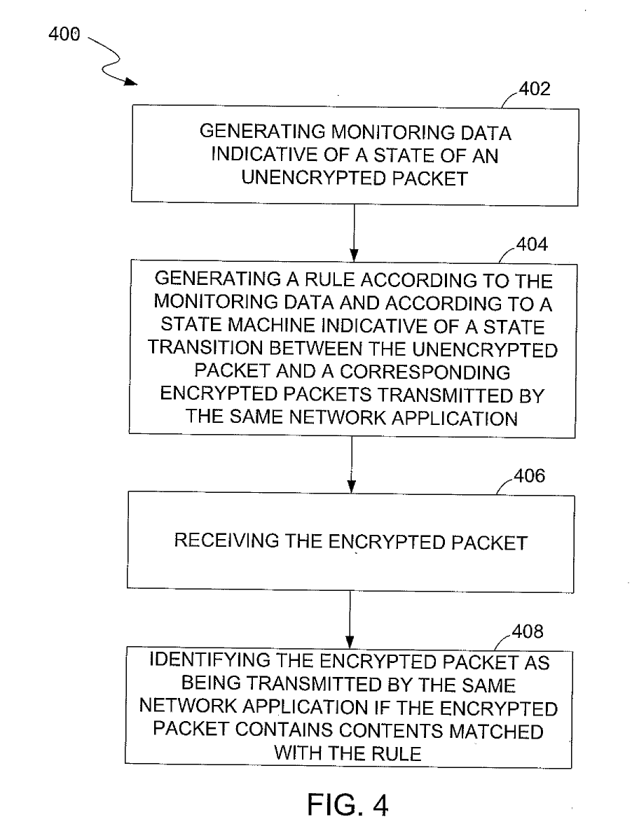

FIG. 4 illustrates a flowchart 400 of operations performed by the application identification device 110, in accordance with one embodiment of the present invention. In one embodiment, the flowchart 400 can be implemented as computer-executable instructions stored in a computer-readable medium. FIG. 4 is described in combination with FIG. 1, FIG. 2, FIG. 3A, FIG. 3B and FIG. 3C. Although specific steps are disclosed in FIG. 4, such steps are exemplary. That is, the present invention is well suited to performing various other steps or variations of the steps recited in FIG. 4.

In block 402, monitoring data, e.g., the monitoring data 252, indicative of a state of an unencrypted packet is generated. In block 404, a rule, e.g., the rule 256, is generated according to the:monitoring data 252 and according to a state machine, e.g., the state machine 254, indicative of a state transition between the unencrypted packet and a corresponding encrypted packet transmitted by the same network application. In block 406, an encrypted packet is received. In block 408, the encrypted packet is identified as being transmitted by the same network application if the encrypted packet contains contents matched to the rule.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An application identification system comprising:
a network interface operable for receiving first and second packets transmitted by a network application;
a signature monitor coupled to said network interface operable for identifying said network application based on said first packet and for generating monitoring data indicative of a state of said first packet;
a rule generator coupled to said signature monitor operable for generating a rule according to said monitoring data and according to a state machine indicative of a state transition between said first and second packets; and
a packet access controller coupled to said rule generator operable for identifying said network application if said second packet contains contents matched to said rule.

2. The application identification system as claimed in claim 1, wherein said first packet comprises an unencrypted packet, and wherein said second packet comprises a corresponding encrypted packet.

3. The application identification system as claimed in claim 1, further comprising:
a signature database coupled to said signature monitor operable for storing a plurality of predetermined signatures indicative of a plurality of target network applications respectively,
wherein said signature monitor identifies said network application by comparing contents of said first packet with said predetermined signatures.

4. The application identification system as claimed in claim 1, further comprising:
a state database coupled to said rule generator operable for storing a plurality of state machines indicative of a plurality of state transitions associated with a plurality of target network applications, respectively,
wherein said rule generator selects said state machine indicative of said state transition between said first and second packets from said state database based on said monitoring data.

5. The application identification system as claimed in claim 1, wherein said monitoring data comprises an application identity indicative of an identity of said network application, a protocol type used by said first packet, a source IP address indicative of an IP address of a source node that runs said network application, and a destination IP address indicative of an IP address of a destination node for said first packet.

6. The application identification system as claimed in claim 1, wherein said state machine comprises an application identity indicative of an identity of said network application, a first packet state associated with said first packet and a second packet state associated with said second packet.

7. The application identification system as claimed in claim 6, wherein said rule generator selects said state machine if said application identity and said first packet state associated with said first packet are matched to said monitoring data.

8. The application identification system as claimed in claim 6, wherein said rule generator generates said rule according to a combination of said monitoring data and said second packet state associated with said second packet.

9. The application identification system as claimed in claim 1, wherein said rule is effective for a predetermined time period.

10. The application identification system as claimed in claim 1, further comprising:
a rule database coupled to said rule generator and to said packet access controller and operable for storing said rule.

11. A computer-readable medium having a plurality of computer-executable components for identifying a network application, said computer-executable components comprising:
a signature monitor operable for identifying said network application based on a first packet transmitted by said network application and for generating monitoring data indicative of a state of said first packet;
a rule generator operable for generating a rule according to said monitoring data and a state machine, wherein said state machine is indicative of a state transition between said first packet and a second packet transmitted by said network application; and
a packet access controller operable for identifying said network application if said network application transmits said second packet containing contents matched to said rule.

12. The computer-readable medium as claimed in claim 11, wherein said first packet comprises an unencrypted packet, and wherein said second packet comprises a corresponding encrypted packet.

13. The computer-readable medium as claimed in claim 11, wherein said computer-executable components further comprises a signature database operable for storing a plurality of predetermined signatures indicative of a plurality of target network applications, respectively, and wherein said network application is identified if said first packet contains contents matched to one of said predetermined signatures.

14. The computer-readable medium as claimed in claim 11, wherein said computer-executable components further comprises a state database operable for storing a plurality of state machines indicative of a plurality of state transitions associated with a plurality of target network applications, respectively, and wherein said state machine indicative of said state transition between first and second packets is selected based on said monitoring data.

15. The computer-readable medium as claimed in claim 11, wherein said monitoring data comprises an application identity indicative of an identity of said network application that transmits said identified first packet, a protocol type used by said identified first packet, a source IP address indicative of an IP address of a source node that runs said network application, a destination IP address indicative of an IP address of a destination node for said identified first packet, a source port indicative of a port used by said identified first packet at said source node, and a destination port indicative of a port used by said identified first packets at said destination node.

16. The computer-readable medium as claimed in claim 11, wherein said state machine comprises an application identity indicative of an identity of said network application, a first packet state associated with said first packet and a second packet state associated with said second packet.

17. The computer-readable medium as claimed in claim 16, wherein said state machine is selected if said application identity and said first packet state associated with said first packet are matched to said monitoring data.

18. The computer-readable medium as claimed in claim 16, wherein said rule is generated according to a combination of said monitoring data and said second packet state associated with said second packet.

19. The computer-readable medium as claimed in claim 11, wherein said rule is effective for a predetermined time period.

20. The computer-readable medium as claimed in claim 11, wherein said computer-executable components further comprise a rule database for storing said rule.

21. A method for identifying a network application, said method comprising:
generating monitoring data indicative of a state of a first packet transmitted by said network application;
generating a rule according to said monitoring data and according to a state machine indicative of a state transition between said first packet and a second packet transmitted by said network application;
receiving said second packet; and
identifying said network application if said second packet contains contents matched to said rule.

22. The method as claimed in claim 21, wherein said first packet comprises an unencrypted packet, and wherein said second packet comprises a corresponding encrypted packet.

23. The method as claimed in claim 21, further comprising:
accessing a plurality of predetermined signatures indicative of a plurality of target network applications, respectively; and
identifying said network application if contents contained in said first packet are matched to one of said predetermined signatures.

24. The method as claimed in claim 21, further comprising:
accessing a plurality of state machines indicative of a plurality of state transitions associated with a plurality of target network applications, respectively; and
selecting said state machine indicative of said state transition associated with said network application from said state machines based on said monitoring data.

25. The method as claimed in claim 21, wherein said rule is effective for a predetermined time period.

26. A computer-readable medium having a plurality of computer-executable components for identifying a network application, said computer-executable components comprising:
an unencrypted packet identifier operable for identifying said network application based on an unencrypted packet transmitted by said network application, and for generating a rule based on said unencrypted packet and a state machine, wherein said state machine indicates a state transition between said unencrypted packet and a corresponding encrypted packet transmitted by said network application; and
an encrypted packet identifier operable for identifying said network application if said network application transmits said corresponding encrypted packet containing contents matched to said rule.

27. The computer-readable medium as claimed in claim 26, wherein said unencrypted packet identifier comprises a signature database operable for storing a plurality of predetermined signatures indicative of a plurality of target network applications, respectively, and wherein said network application is identified if said unencrypted packet contains contents matched to one of said predetermined signatures.

28. The computer-readable medium as claimed in claim 26, wherein said unencrypted packet identifier comprises a state database operable for storing a plurality of state machines indicative of a plurality of state transitions associated with a plurality of network applications, respectively, and wherein said state machine indicative of said state transition between said unencrypted and encrypted packet is selected based on said unencrypted packet.
